(19) United States
(12) Patent Application Publication
(10) Pub. No.: US 2019/0087482 A1
(43) Pub. Date: Mar. 21, 2019

(54) SMART DEVICE AND METHOD FOR CREATING PERSON MODELS

(71) Applicants: Fu Tai Hua Industry (Shenzhen) Co., Ltd., Shenzhen (CN); HON HAI PRECISION INDUSTRY CO., LTD., New Taipei (TW)

(72) Inventor: XUE-QIN ZHANG, Shenzhen (CN)

(21) Appl. No.: 15/826,695

(22) Filed: Nov. 30, 2017

(30) Foreign Application Priority Data
Sep. 18, 2017 (CN) 201710842545.0

(51) Int. Cl. G06F 17/30

(52) U.S. Cl. CPC G06F 17/30598; G06N 3/04; G06F 17/30528

(57) ABSTRACT

A method of creating person models applied to a smart devices including obtaining related information of the user, wherein the related information of the user comprises basic information of the user and event information related to the user. Key information is extracted from the event information of the user. Person models are created for the user by searching a predetermined database according to the key information; and a relationship between the person models and the basic information of the user is established.

### CROSS-REFERENCE TO RELATED APPLICATIONS

This application claims priority to Chinese Patent Application No. 201710842545.0 filed on Sep. 18, 2017, the contents of which are incorporated by reference herein.

### FIELD

The subject matter herein generally relates to managing technology, and particularly to a smart device and a method of creating person models.

### BACKGROUND

Currently, robots cannot interact with human according to character of human. Therefore, there is a room for improvement in the field.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an exemplary embodiment of a smart device.

FIG. 2 is a block diagram of an exemplary embodiment of modules of a creation system included in the smart device of FIG. 1.

FIG. 3 is a flowchart of an exemplary embodiment of a method of creating person models.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” exemplary embodiment in this disclosure are not necessarily to the same exemplary embodiment, and such references mean “at least one.”

Furthermore, the term “module”, as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

The smart device 1 can include, but is not limited to, a creation system 10, a microphone 11, a camera 12, a storage device 13, and at least one processor 14. In at least one exemplary embodiment, the smart device 1 can be a robot, or other kind of intelligent device. In at least one exemplary embodiment, the creation system 10 can create person models for at least one user 2. The person models can include, but is not limited to, a mental model, a character model, and a cognitive model. The mental model defines a psychological states of the user 2. The character model defines a character of the user 2. The cognitive model defines an opinion of the user 2 on a particular event. Details of the person models will be provided below.

In at least one exemplary embodiment, the microphone 11 can be used to gather voice data. The camera 12 can be used to capture images of the user 2 or capture images of a scene. For example, the camera 12 can capture an image of words on paper.

The storage device 13 can be used to store all kinds of data such as program codes of the creation system 10. In at least one exemplary embodiment, the storage device 13 can be an internal storage device such as a memory of the smart device 1. In other exemplary embodiments, the storage device 13 can be an external storage device such as a secure digital card or a cloud storage device of the smart device 1.

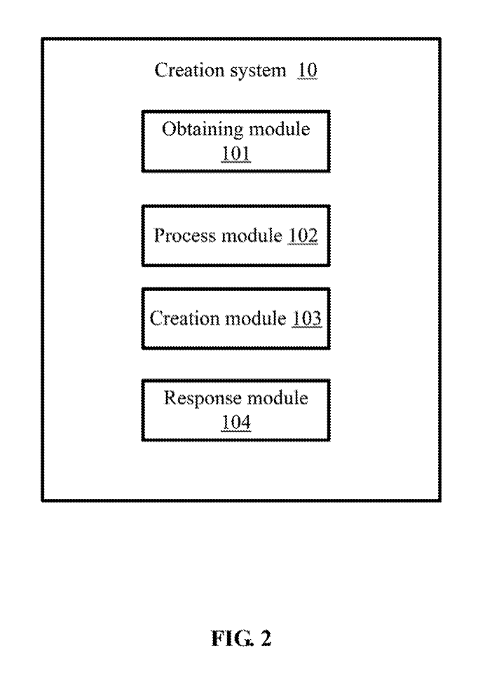

FIG. 2 is a block diagram of an exemplary embodiment of modules of the creation system 10. In at least one exemplary embodiment, the creation system 10 can include an obtaining module 101, a process module 102, a creation module 103, and a response module 104. The modules 101-104 include computer instructions or codes in the form of one or more programs that may be executed by the at least one processor 13.

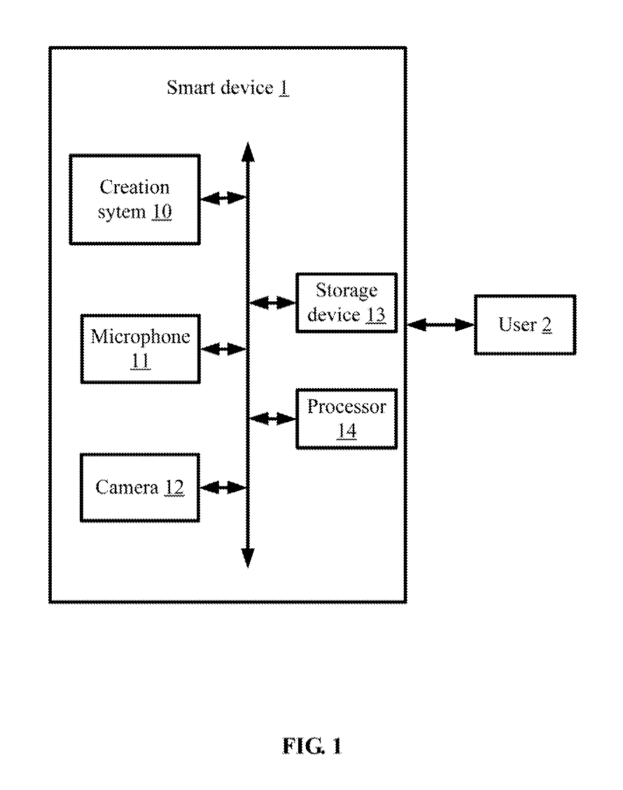

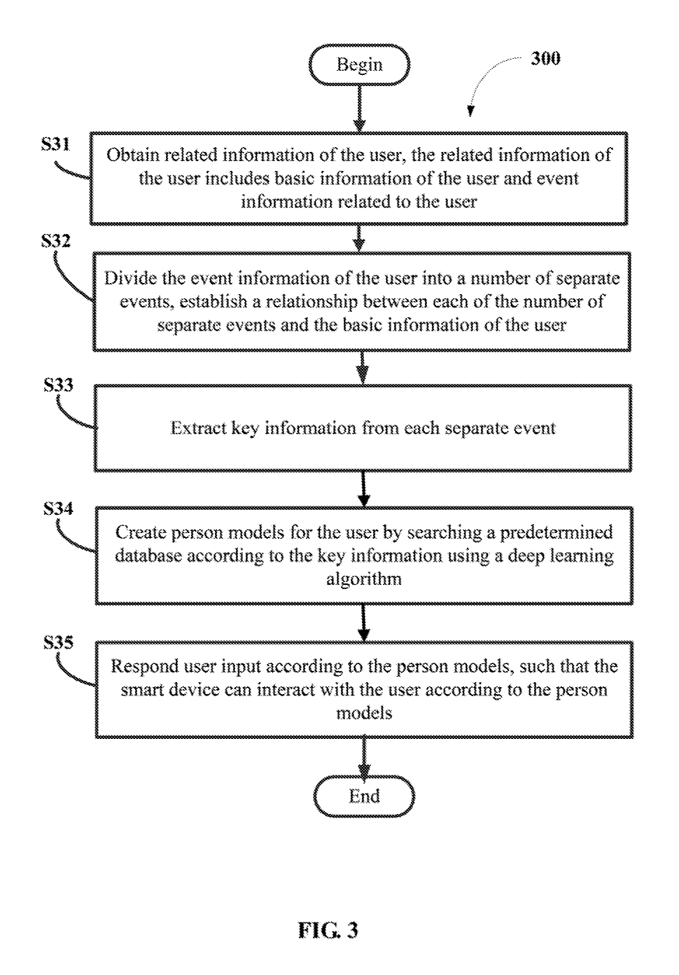

FIG. 3 illustrates an exemplary embodiment of a flowchart of a method of creating person modules. The example method 300 is provided by way of example, as there are a variety of ways to carry out the method. The method 300 described below can be carried out using the configurations illustrated in FIG. 1, for example, and various elements of these figures are referenced in explaining example method 300. Each block shown in FIG. 3 represents one or more processes, methods, or subroutines, carried out in the example method 300. Additionally, the illustrated order of blocks is by example only and the order of the blocks can be changed. The example method 300 can begin at block 31. Depending on the exemplary embodiment, additional steps can be added, others removed, and the ordering of the steps can be changed.

At block 31, the obtaining module 101 can obtain related information of the user 2. In at least one exemplary embodiment, the related information of the user 2 can include, but is not limited to, basic information of the user 2, and event information related to the user 2.

In at least one exemplary embodiment, the basic information of the user 2 can include, but is not limited to, a gender, a name, an age, a body height, a body weight, a body type, and a face type of the user 2. In at least one exemplary embodiment, the body type may be a big body type, a middle-size body type, a small body type, or a standard body type. The body type can be defined according to the body weight of the user 2. For example, when the body weight of the user 2 surpasses a standard body weight above 20%, the body type of the user 2 can be defined to be the big type. When the body weight of the user 2 surpasses the standard body weight 10%˜20%, the body type of the user 2 can be defined to be the middle-size body type. When the body weight of the user 2 surpasses the standard body weight −10%˜10%, the body type of the user 2 can be defined to be the standard body type. When the body weight of the user 2 surpasses the standard body weight under −10%, the body type of the user 2 can be defined to be the small body type. In at least one exemplary embodiment, the standard body weight is the standard weight defined in the World Health Organization.

In at least one exemplary embodiment, the event information related to the user 2 can be a record of an event related to the user 2 that occurred at a certain time and a certain position. The record can be text data. In at least one exemplary embodiment, the obtaining module 101 can obtain the related information of the user 2 using the microphone 11 and/or the camera 12.

For example, the obtaining module 101 can obtain voice data of the user 2 using the microphone 11. The obtaining module 101 can recognize the voice data by converting the voice data to be text data, and set the text data to be the related information of the user 2. In at least one exemplary embodiment, the obtaining module 101 can preprocess the voice data before recognizing the voice data. The preprocessing of the voice data can include, but is not limited to, de-noising the voice data, such that the voice data can be recognized more accurately.

In at least one exemplary embodiment, the basic information of the user 2 can further include voiceprint of the user 2. The obtaining module 101 can obtain the voiceprint of the user 2 from the voice data using a voice print recognition technology.

In at least one exemplary embodiment, the user 2 can speak to the microphone 11 about the basic information of the user 2, such that the obtaining module 101 can obtain the basic information of the user 2 using the microphone 2. Similarly, the user 2 can speak to the microphone 11 about the event information related to the user 2, such that the obtaining module 101 can obtain the event information related to the user 2 using the microphone 2. The obtaining module 101 can convert the voice data received from the microphone 11 to be text data, and set the text data to be the event information related to the user 2.

According to the above method, the obtaining module 101 can obtain the related information of more than one users 2.

In at least one exemplary embodiment, the obtaining module 101 can establish a file (e.g., a word file) for each user 2, and record event information of each user 2 in the file. In at least one exemplary embodiment, when one user 2 corresponds to more than one events, each of the more than one events is recorded in one paragraph. In other words, each paragraph corresponds to information of one event.

In at least one exemplary embodiment, the obtaining module 101 can obtain the related information of the user 2 using the camera 12. For example, the obtaining module 101 can control the camera 12 to capture an image of a paper or a display which shows the basic information and the event information of the user 2 using words. The obtaining module 101 can recognize the related information of the user 2 from the captured image using optical character recognition (OCR) technology.

In at least one exemplary embodiment, the obtaining module 101 can directly capture a video of the user 2 using the camera 12. The user 2 can speak to the camera 12 and give basic information of the user 2 such as the gender, name, age, body weight, and so on. The obtaining module 101 can recognize the gender, name, age, and body weight. The voiceprint of the user 2 can be recognized from the video using a speech recognition technology. The obtaining module 101 can also recognize the body type, and face type of the user 2 from the video using image recognition technology.

At block S32, the process module 102 can divide the event information of the user 2 into a number of separate events. The process module 102 can further establish a relationship between each separate event and the basic information of the user 2.

For example, the process module 102 can divide the event information of a user “A” into a first event and a second event. The process module 102 can establish a relationship between the first event and the basic information of the user “A”. The process module 102 can establish a relationship between the second event and the basic information of the user “A”.

In at least one exemplary embodiment, the process module 102 can divide the event information of the user 2 into the number of separate events using the semantic network. In other exemplary embodiments, the processing module 102 can divide the event information of the user 2 into the number of separate events according to separate paragraphs of the file that records event information of the user 2, each paragraph representing a separate event.

In at least one exemplary embodiment, the semantic network can be BosonNLP semantic network, or Chinese core frame semantic analysis.

In other exemplary embodiments, block S32 may be deleted. In other words, when the block S31 is executed, the process goes to block S33. The processing module 102 can directly extract key information from the event information of the user 2.

At block S33, the process module 102 can extract key information from each separate event. Key information corresponding to each separate event can include, but is not limited to, a position where the separate event occurred, time when the separate event occurred, other people involved in the separate event, a progress and a result of the separate event, a participation level of the user 2 in the separate event, an attitude of the user 2 to the separate event, a psychological state and the characteristics of the user 2 in relation to the separate event, a hobby of the user 2, interpersonal relationships of the user 2, a will and spirit of the user 2, and other information. In other exemplary embodiments, the key information corresponding to each separate event can further include a certain type of action of the involved people, and a result of the certain action. For example, the certain type of action may be a boxing motion, and the result may be winning or losing.

In at least one exemplary embodiment, the participation level of the user 2 in the separate event may be watching, participating, indirect participating, or passive participating. The attitude of the user to the separate event can be against, agree, contradiction, and other attitudes. The psychological state of the user 2 can be satisfaction, sorrow, sense of inferiority, and others. The character of the user 2 can be perfectionist, a high achiever, a loyal type, an active or inactive type, and others. The hobby of the user 2 can be karaoke, dancing, climbing, travel, reading, and others. The interpersonal relationship of the user 2 can be such as the user 2 being a brother or a neighbour of other people involved in the event. The will and spirit of the user 2 can be resolute, fearful, easygoing, uncaring, and others.

In at least one exemplary embodiment, the process module 102 can extract the key information from each separate event using information extraction techniques.

In at least one exemplary embodiment, the process module 102 can extract data of a predetermined type of event, a relation to the user 2, and event itself from a text of each separate event using the information extraction techniques.

The processing module 102 can construct the extracted data to be structural data and output the structural data. For example, data can be extracted from a news report regarding natural disasters including the type of the natural disaster, the time and place it happened, casualties, and economic losses.

In other exemplary embodiments, the process module 102 can extract key information from each separate event using automatic summarization technology, and/or natural language processing (NLP) algorithm.

In at least one exemplary embodiment, the process module 102 can further establish a relationship between the key information and the user 2, and further store the relationship in the storage device 13.

The process module 102 can create an information record for each user 2. The information record for each user 2 can include key information of all events experienced by the user 2. The information record can be a file in a predetermined format such as MS WORD or EXCEL format.

In at least one exemplary embodiment, the process module 102 can arrange the key information of all events experienced by the user 2 according to time of occurrence of each event.

The information record can be used when the user 2 needs psychological guidance, psychological counseling, or psychological management.

At block S34, the creation module 103 can create person models for the user 2 by searching a predetermined database according to the key information using a deep learning algorithm.

The deep learning algorithm can include, but is not limited to, recurrent neural networks (RNN), and convolutional neural network (CNN).

The person models can include, but is limited to, the mental model, the character model, and the cognitive model.

In at least one exemplary embodiment, the mental model, character model, and the cognitive model are defined using key words.

In at least one exemplary embodiment, the creation module 103 can establish a relationship between the person models and the basic information of the user 2. The creation module 103 can further store the relationship in the storage device 13.

In at least one exemplary embodiment, the predetermined database can include, but is not limited to, an ethical knowledge base, a legal knowledge base, a psychology knowledge base, a religious knowledge base, and an astronomical knowledge base.

In at least one exemplary embodiment, the predetermined database predetermines key words which correspond to different kinds of mental models. For example, a positive mental model might correspond to key words such as joyful, happy, glad, pleasant, or relaxed. A pessimistic mental model might correspond to key words such as tired, nervous, or distressed.

In at least one exemplary embodiment, the predetermined database predetermines key words corresponding to different kinds of character models. For example, an extroverted character model corresponds to key words such as enthusiastic, active, generous, and humorous. A introverted character model might correspond to key words such as weak, shy, slow, quiet, or passive.

In at least one exemplary embodiment, the predetermined database predetermines key words which correspond to different kinds of cognitive models. For example, a first cognitive model might correspond to key words such as agreeable, approving, or permissive or easygoing. A second cognitive model might correspond to key words such as unsociable, bossy, or non-cooperative.

At block S35, the response module 104 can respond to user 2 according to the person models, such that the smart device 1 can interact with the user 2 according to the person models.

For example, when the response module 104 determines that the user 2 currently corresponds to a pessimistic mental model, then the response module 104 can interact with the user 2 by applying an upbeat tone.

It should be emphasized that the above-described exemplary embodiments of the present disclosure, including any particular exemplary embodiments, are merely possible examples of implementations, set forth for a clear understanding of the principles of the disclosure. Many variations and modifications can be made to the above-described exemplary embodiment(s) of the disclosure without departing substantially from the spirit and principles of the disclosure. All such modifications and variations are intended to be included herein within the scope of this disclosure and protected by the following claims.

What is claimed is:

1. A smart device, comprising:
a storage device; and
at least one processor, wherein the storage device stores one or more programs, which when executed by the at least one processor, cause the at least one processor to:
obtain related information of the user, wherein the related information of the user comprises basic information of the user and event information related to the user;
extract key information from the event information of the user;
create person models for the user by searching a predetermined database according to the key information; and
establish a relationship between the person models and the basic information of the user.

2. The smart device according to claim 1, wherein before the extracting of the key information, the at least one processor is further caused to:
dividing the event information of the user into a number of separate events; and
establishing a relationship between each of the number of separate events and the basic information of the user.

3. The smart device according to claim 2, wherein the at least one processor is further caused to:
arrange the key information of the number of separate events according to occurred time of each separate event.

4. The smart device according to claim 1, wherein the at least one processor is further caused to:
interact with the user according to the person models.

5. The smart device according to claim 1, wherein the at least one processor is further caused to:
obtain the related information of the user using a microphone and/or a camera.

6. The smart device according to claim 1, wherein the person models are defined using keywords, the basic information of the user comprises a gender, a name, an age, a body height, a body weight, a body type, and a face type of the user, the event information related to the user is a record of an event related to the user that is occurred at a certain time and a certain position.

7. A method of creating person models applied to a smart devices, the method comprising:
obtaining related information of the user, wherein the related information of the user comprises basic information of the user and event information related to the user;
extracting key information from the event information of the user;
creating person models for the user by searching a predetermined database according to the key information; and
establishing a relationship between the person models and the basic information of the user.

8. The method according to claim 7, wherein before the extracting of the key information, the method further comprising:
dividing the event information of the user into a number of separate events; and
establishing a relationship between each of the number of separate events and the basic information of the user.

9. The method according to claim 8, further comprising:
arranging the key information of the number of separate events according to occurred time of each separate event.

10. The method according to claim 7, further comprising:
interacting with the user according to the person models.

11. The method according to claim 7, further comprising:
obtaining the related information of the user using a microphone and/or a camera.

12. The method according to claim 7, wherein the person models are defined using keywords, the basic information of the user comprises a gender, a name, an age, a body height, a body weight, a body type, and a face type of the user, the event information related to the user is a record of an event related to the user that is occurred at a certain time and a certain position.

13. A non-transitory storage medium having instructions stored thereon, when the instructions are executed by a processor of a smart device, the processor is configured to perform a method of creating person models, wherein the method comprises:
obtaining related information of the user, wherein the related information of the user comprises basic information of the user and event information related to the user;
extracting key information from the event information of the user;
creating person models for the user by searching a predetermined database according to the key information; and
establishing a relationship between the person models and the basic information of the user.

14. The non-transitory storage medium according to claim 13, wherein before the extracting of the key information, the method further comprises:
dividing the event information of the user into a number of separate events; and
establishing a relationship between each of the number of separate events and the basic information of the user.

15. The non-transitory storage medium according to claim 14, further comprising:
arranging the key information of the number of separate events according to occurred time of each separate event.

16. The non-transitory storage medium according to claim 13, further comprising:
interacting with the user according to the person models.

17. The non-transitory storage medium according to claim 13, further comprising:
obtaining the related information of the user using a microphone and/or a camera.

18. The non-transitory storage medium according to claim 13, wherein the person models are defined using keywords, the basic information of the user comprises a gender, a name, an age, a body height, a body weight, a body type, and a face type of the user, the event information related to the user is a record of an event related to the user that is occurred at a certain time and a certain position.
